(19) United States
(12) Patent Application Publication
(10) Pub. No.: US 2025/0134113 A1
(43) Pub. Date: May 1, 2025

(54) MIXING SYSTEM

(71) Applicant: ZIMPLISTIC PRIVATE LIMITED, Singapore (SG)

(72) Inventors: Pranoti Nagarkar ISRANI, Bangalore (IN); Rishi ISRANI, Bangalore (IN)

(73) Assignee: ZIMPLISTIC PRIVATE LIMITED, Singapore (SG)

(21) Appl. No.: 18/839,982

(22) PCT Filed: Feb. 21, 2023
(86) PCT No.: PCT/SG2023/050105

§ 371 Date: Aug. 20, 2024

(30) Foreign Application Priority Data
Feb. 21, 2022 (SG) 10202201691T

(51) Int. Cl. A21C 1/02; A21C 1/00; A21C 1/14; A21C 11/00

(52) U.S. Cl. CPC A21C 1/02; A21C 1/006; A21C 1/1405; A21C 1/1445; A21C 1/146; A21C 1/1465; A21C 11/006

(57) ABSTRACT

Disclosed is a mixing system for making a dough ball. The mixing system comprises a cup for receiving a plurality of ingredients to be mixed, the cup comprising a base and side wall. The mixing system also comprises a blade for mixing the ingredients in the cup to develop the dough ball, the blade and cup together defining a mixing volume, and a drive system for moving at least one of the blade and the cup to change a size of the mixing volume.

### FIELD OF THE INVENTION

The present invention relates to a mixing system for making a dough ball. More particularly, the present invention relates to a mixing system for adjusting the size of a mixing volume before and/or during mixing. The present invention also relates to an apparatus for making flat edibles, comprising such a mixing system.

### BACKGROUND OF THE INVENTION

Flat edibles such as roti, tortilla, flatbreads and pita are part of the common diet in many different cultures. These flat edibles are typically best eaten when made fresh and, as such, they are typically prepared before each meal.

Flat edibles are generally made by hand due to difficulties in automating the process of dough ball development, pressing and cooking. Automated systems usually comprise a mixing bowl and blade. In such systems it is common that some ingredients will not be automatically incorporated into the dough ball. Instead, they will remain in the mixing bowl in areas where the blade cannot readily access them. To incorporate those ingredients into the dough ball requires additional manual work.

During mixing of the ingredients, gluten develops. Gluten development results in the mixture increasing in volume when compared with the combined volumes of the separate ingredients. As such, the volume required for mixing increases during dough ball formation (also called “development”). To account for this, automated systems include an enlarged mixing bowl and the blade is driven by a central shaft so that the dough can develop around the blade. However, this results in dough sticking to the shaft and upper surfaces of the blade.

Control of ingredients dispensing and the mixing process can also be complex for automated systems. It is difficult for automated systems to know whether the correct ratios of ingredients have been dispensed, and to know when the dough ball has developed so as to cease working the dough ball.

It is generally desirable to overcome or ameliorate one or more of the above described difficulties, or to at least provide a useful alternative.

### SUMMARY OF THE INVENTION

Disclosed is a mixing system for making a dough ball, comprising:
a cup for receiving a plurality of ingredients to be mixed, the cup comprising a base and side wall;
a blade for mixing the ingredients in the cup to develop the dough ball, the blade and cup together defining a mixing volume; and
a drive system for moving at least one of the blade and the cup to change a size of the mixing volume.

The drive system may move at least one of the blade and the cup to change a size of the mixing volume during development of the dough ball. The drive system may change the size of the mixing volume depending on at least one of mixing time and a degree of dough ball development.

The drive system may comprise a first drive for driving the blade to mix the ingredients, and a second drive for moving the cup towards and away from the blade to change the size of the mixing volume. The second drive may be configured to tilt the cup to dispense the dough ball.

The blade may be connected to the drive system by a magnetic mount.

The blade may comprise a pressing projection on a lower surface for repeatedly depressing the ingredients with movement of the blade by the drive system, during formation of the dough ball.

The blade may comprise a central bulb.

The base may comprise an upper surface with one or more protrusions.

The drive system may comprise a load detection system for detecting a weight of ingredients dispensed into the cup. The drive system may separate the blade from the base during dispensing of ingredients into the cup.

The drive system may monitor development of the dough ball based on an energy input during mixing. Where the drive system comprises a load detection system the drive system may determine the energy input based on a weight measurement detected by the load detection system.

Also disclosed is an apparatus for making flat edibles, comprising:
a mixing system described above; and
a cooking assembly for cooking the dough ball, wherein the drive system causes the dough ball, after formation of the dough ball, to be deposited in or on the cooking assembly.

Also disclosed is a method for forming a dough ball comprising:
spacing a blade from a base of a mixing cup to define a mixing volume;
dispensing a plurality of ingredients into the mixing volume;
moving the blade towards the ingredients; and
driving the blade using a drive system to mix the ingredients in the cup to develop the dough ball.

Driving the blade using a drive system to mix the ingredients in the cup to develop the dough ball may comprise changing a size of the mixing volume during mixing of the ingredients.

Advantageously, in some embodiments the blade comprises a bin on an upper surface for receiving ingredients that have been dispensed from the dispenser and not landed in the mixing cup. This avoids spillage internally of systems used to form flat edibles from dough balls made in the mixing system described above.

Advantageously, the central bulb in embodiments of the blade causes ingredients to be pushed away from the centre of the base of the cup into the path of the dough ball being kneaded. This decreases the amount of ingredients that are not automatically incorporated into the dough ball.

### BRIEF DESCRIPTION OF THE DRAWINGS

Preferred embodiments of the invention are hereafter described, by way of non-limiting example only, with reference to the accompanying drawings, in which:

FIG. 1 is an apparatus for making flat edibles, incorporating a mixing system for making a dough ball in accordance with present teachings;

FIG. 2 shows a cross-section of an apparatus for making flat edibles, incorporating a mixing system for making a dough ball in accordance with present teachings;

FIG. 3A is a view of a dispenser and mixing system, FIGS. 3B and 3C are top and bottom perspective views of a dispenser and mixing unit of an alternative embodiment;

FIG. 4 is a processing member of a mixing unit in accordance with present teachings;

FIG. 5 is a cross-section view of the mixing unit of FIG. 4; and

FIG. 6 is a computer system representation of the apparatus of FIG. 1, for controlling various processes performed by that apparatus.

### DETAILED DESCRIPTION OF EMBODIMENTS OF THE INVENTION

Disclosed herein are arrangements for mixing ingredients to form a dough ball. Some of those arrangements ensure that deposits of ingredients do not remain in the mixing cup, unincorporated into the dough ball, ensure that ingredients do not miss the cup during dispensing and then end up elsewhere inside a cooking system, and assist with controlling the apparatus in a manner that is flexible enough to handle different types of ingredients and different sizes and shapes of the dough ball as it forms or develops.

As described hereafter, the terms “flat edible”, “cooked flat edible” and “roti” may be used interchangeably. It will be understood, however, that the flat edible may be a product other than a roti, without falling outside the scope of the present disclosure. The term “roti”, where used, is for illustration purposes only.

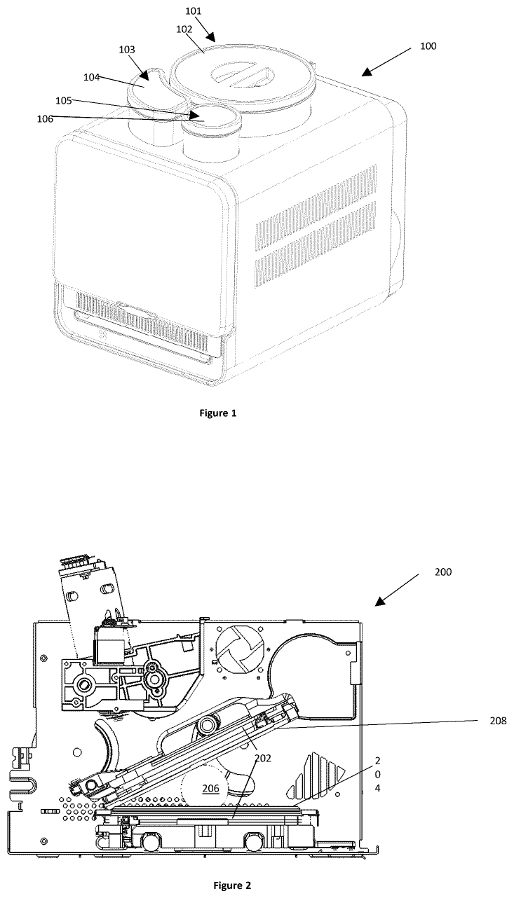

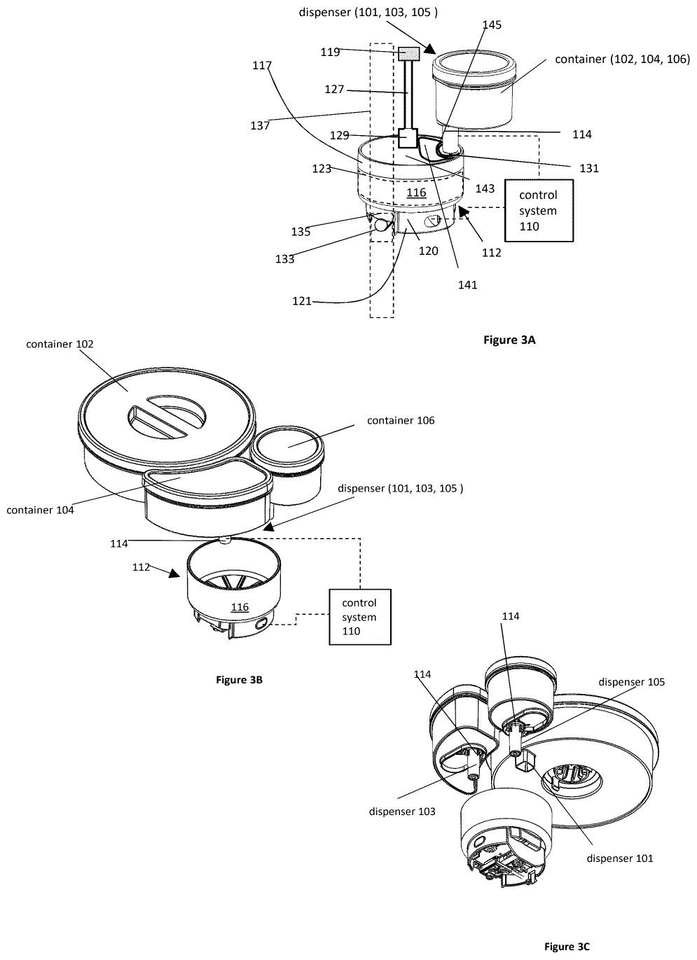

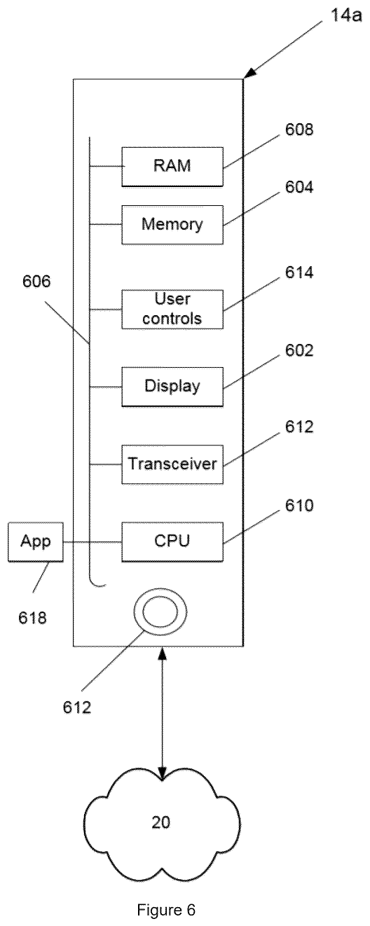

With reference to FIG. 1, an apparatus 100 for producing flat edibles is shown. The apparatus 100 can be broadly separated into a mixing system as described herein, and a cooking assembly for cooking a dough ball produced by the mixing system, wherein the drive system of the mixing system causes a formed dough ball to be deposited in or on the cooking assembly. Broadly, the apparatus 100 includes:
(a) two or more dispensers 101, 103, 105 each of which is associated with a container 102, 104, 106;
(b) a weighing device 108 (see FIG. 6);
(c) a control system 110 (see FIG. 3A); and
(d) a mixing system/unit 112 (see FIG. 3A).

Limited to these components, the apparatus 100 can be used for—as in, in the process of—making flat edibles. Under control of the control system 110, the apparatus 100 will produce a consistent mixture that can be cooked to produce the flat edible. In some embodiments, the apparatus 100 itself also operates to cook the mixture into a flat edible.

With reference to apparatus 200 in FIG. 2, the control system 110 can adjust the amount of time the mixing unit mixes the mixture or the amount of time the heating mechanism 202 heats the flattened mixture to adjust for the user input.

The cup (i.e. container or mixing container) 116 is used for mixing and kneading the ingredients. In some embodiments, the base (i.e. bottom) 124 of the cup 116 opens (e.g. is hinged) to allow the dough ball to drop from the cup 116 onto a cooking/heating platen 204 and/or to a transfer mechanism for properly positioning the mixture (e.g. dough ball 206) on the cooking/heating platen 204—i.e. in a position to facilitate cooking of the mixture. In the embodiment shown, platens 204, 208 come together to press the dough ball to form the shape of a flat edible. In other embodiments, the cup 116 tips to roll the mixture 206 from the top of the cup 116 either into a transfer mechanism and/or onto the heating/cooking platen 204.

Each container 102, 104, 106 is in communication with a dispensing mechanism 114 as best seen in FIG. 3A. The dispensing mechanism 114 is controlled by the control system 110 to dispense the respective ingredient from the container 102, 104, 106.

The dispensing mechanism 114 and container 102, 104, 106 may form separate parts of the apparatus 100, or be an integral unit.

Each dispenser 101, 103, 105 is controlled by the control unit 110 to dispense the respective ingredient. Each dispenser 101, 103, 105 is therefore selectively operated or actuated to produce the dispensing function.

With reference to FIG. 3A, the mixing system 112 used for making a dough ball, broadly comprises:
a cup 116;
a blade 117; and
a drive system, presently embodied by separate drives 119, 121.

The mixing system 112 operates under the control of control system 110. During mixing, the control system 110 will control dispensing of ingredients from dispensers 101, 103, 105 into the cup 116, and operation of the drive system.

The drive system controls the drive of the blade 117 to mix the ingredients. The drive system also moves one or both of the blade 117 and the cup 116 two change the size of the mixing volume 123. In this regard, the mixing volume 123 is the volume within the cup 116 that is defined by a bottom surface of the blade 117, and the base 124 and sidewall 125 of the cup 116.

While the drive system may comprise a single drive or motor to perform all of the required functions, the present drive system comprises a first drive 119 and a second drive 121. The first drive 119 drives the blade 117 to mix the ingredients that have been deposited into cup 116. The second drive 121 moves the cup 116 towards and away from the blade 117 to change the size of the mixing volume 123.

The first drive 119 may be a simple motor to impart a rotary motion through shaft 127 to the blade 117. It may alternatively be any other suitable drive.

The blade 117 is connected to the drive system, particularly first drive 119, by a magnetic mount 129. To that end, shaft 127 will include a corresponding magnet or magnetic material to hold the blade 117 in position on the shaft 127. The magnetic mount 129 may be internally or externally keyed to remain securely in position on the end of shaft 127 which will therefore be oppositely externally or internally keyed.

This enables the blade 117 to be easily removed from the shaft 127 without requiring tools.

The second drive 121 may comprise one or more motors. The second drive 121 is configured to tilt the cup 116 to dispense the dough ball once the dough ball has been formed. To that end, the cup 116 is mounted to a tilt mechanism presently embodied by a shaft 133 mounted to a travel body 135. The shaft 133 is rotated to tilt the cup 116.

The second drive 121 also drives the cup 116 towards and away from blade 117 to change the size of the mixing volume 123. To achieve this, the travel body 135 travels vertically along track 137 under the control of the second drive 121. By moving the cup 116 towards the blade 117, the upper surface of the base 124 approaches the lower surface 139 of the blade 117, thereby reducing the size of the mixing volume 123. Conversely, by moving the cup 116 away from the blade 117, the upper surface of the base 124 moves further away from the lower surface 139 of the blade 117, thereby increasing the size of the mixing volume 123.

The cup 116 may connect to the shaft 133, body 135 or track 137 by any desired mechanism such as a push button, or slide click lock system.

While, in some embodiments, the first drive 119 may lift and lower the blade 117 or the drive system may otherwise be configured with only a single drive, the present drive system splits the drive functions between multiple drives 119, 121. By separating the drives 119, 121, the blade 117 can remain a fixed distance from the dispensing mechanism is 114 and/or dispensers 101, 103, 105. This avoids having to raise and lower a heavy motor for driving the blade 117 during mixing, to change the size of the mixing volume 123. This also ensures that ingredients are dispensed at a consistent distance from the blade 117. Relevantly, where the mixing system 112 is an adaptive mixing system, it may require ingredients to be dispensed during the mixing (kneading) process to adjust the consistency of the dough ball.

To enable ingredients to be deposited into the cup 116 without physically moving the blade 117 away from the cup, the blade 117 comprises an opening 131 through which ingredients are dispensed into the cup 116.

By placing the blade 117 a consistent distance, i.e. directly below, the dispensing mechanism 114 pump-less or tubeless dispensers can be used. For example, for dispensing oil or water, each dispenser 101, 103, 105 may be a pumpless, tubeless fluid dispenser. In such embodiments, opening a valve of the dispensing mechanism 114 may cause oil, water or other fluid to drain from the container 102, 104, 106 until the valve is closed. Advantageously, avoiding pumps and tubing ensures a low number of mechanical parts are used, and also reduces redundant fluid volume in tubing. Reducing redundant fluid volume reduces wastage, makes the apparatus 100 easier to clean, and reduces contamination between batches of different types of flat edible.

Where there is a mismatch between the dispensing mechanism 114 and the opening 131, or where ingredients are more viscous or messy to dispense, it is expected that some ingredients will fall to the side of the opening 131 rather than through it. To prevent debris (i.e. ingredients that have missed the opening 131) from dropping inside the apparatus 100, the blade 117 has bin (i.e. recess or receptacle) 141 on its upper surface 143. A small wall 145 between the bin 141 and the opening 131 ensures ingredients are captured in the bin 141 remain in there. The bin 141 is sufficiently deep to prevent debris from coming out of the bin 141 during mixing, and to catch the debris from multiple cooking cycles before being emptied.

FIGS. 3B and 3C show an alternative dispenser arrangement (or an arrangement of which the dispenser of FIG. 3A forms a part). In general, there are at least two dispensers required to dispense ingredients. Typically, one or more of the dispensers will dispense dry, often powdered or granular ingredients from respective containers, and one or more of the dispensers will dispense liquid ingredients. Presently there are three such dispensers 301, 303, 305, for dispensing a corresponding three ingredients (not shown). Each ingredient may be, for example:
(a) flour;
(b) water;
(c) oil;
(d) a dietary supplement—e.g. maca powder, fibre supplement, vitamin supplement and protein powder;
(e) ghee; or
(f) any combination of the above and/or another ingredient.

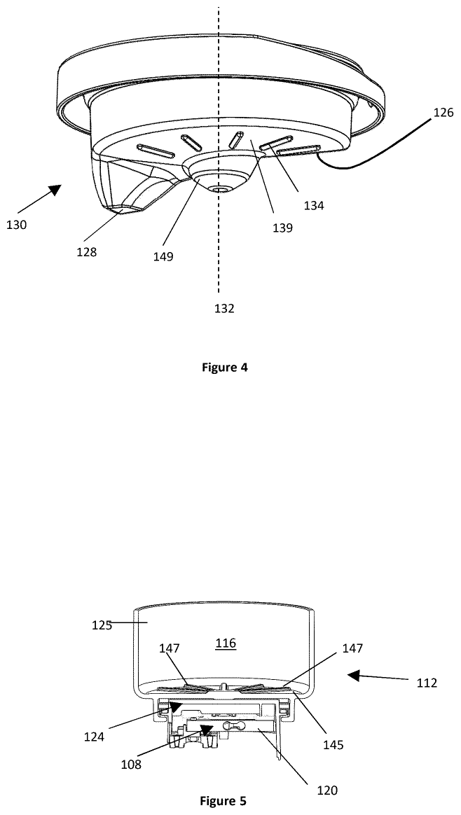

With reference to FIG. 4B, each dispenser 301, 303, 305 may comprise or be coupled to a respective container 302, 304, 306 each containing one of the two or more ingredients. Each container 302, 304, 306 may be used to store the respective ingredient prior to use.

In general, at least one of the two dispensers 301, 303, 305 (there being a dispenser associated with each container 302, 304, 306) will contain or dispense a ground or powdered ingredient such as flour, and another of the two dispensers 301, 303, 305 will contain or dispense a liquid ingredient such as water or oil.

Each container 302, 304, 306 is in communication with a dispensing mechanism 314. The dispensing mechanism 314 is controlled by the control system 110 to dispense the respective ingredient from the container 302, 304, 306.

Each container 302, 304, 306 may be removably attached to a housing of the apparatus or cooking system, be fixed to or integral with the housing. The present disclosure is intended to encompass all configurations in which the container comes into, or is in, communication or engagement with the dispensing mechanism 314 to dispense the ingredient from the container 302, 304, 306.

Similarly, the dispensing mechanism 314 and container 302, 304, 306 may form separate parts of the apparatus or cooking system, or be an integral unit.

Each dispenser 301, 303, 305 is controlled by the control system 110 to dispense the respective ingredient. Each dispenser 301, 303, 305 is therefore selectively operated or actuated to produce the dispensing function. The type of dispensing mechanism 314 may depend on the ingredient—for example, the dispensing mechanism 314 may comprise a valve, for dispensing oil or water, or a worm-drive for dispensing dry substances such a flour.

For dispensing oil or water, each dispenser 301, 303, 305 may be a pumpless, tubeless fluid dispenser. In such embodiments, opening a valve of the dispensing mechanism 314 may cause oil, water or other fluid to drain from the container 302, 304, 306 until the valve is closed. Advantageously, avoiding pumps and tubing ensures a low number of mechanical parts are used, and also reduces redundant fluid volume in tubing. Reducing redundant fluid volume reduces wastage, makes the apparatus or cooking system easier to clean, and reduces contamination between batches of different types of flat edible.

In alternative embodiments, one or more of the dispensing mechanisms 314 may comprise an actuator (e.g., motor, pump, solenoid) to control a flow of ingredients.

A further embodiment of a blade or processing member 130 is shown in FIG. 4. The ingredients enter the container or cup 116 through an aperture or opening 126. In other embodiments, the ingredients enter the container through an aperture or opening in a sidewall of the container.

Once ingredients have been dispensed into the cup 116 through the opening 126, they typically spread unevenly over the base. During mixing (kneading), the bulk of the ingredients will be taken up and incorporated into the dough ball. However, the dough ball typically forms towards the side wall 125 of the cup 116. As a result, ingredients that have collected in the centre of the base 124 immediately after dispensing may not be incorporated into the dough ball.

To avoid this issue, the blade 130 comprises a central bulb 149. The central bulb 149 drives ingredients from the centre of the base 124 closer to the side wall 125 of the cup 116. During mixing, those ingredients will therefore be pushed into the path of the oncoming dough ball as it moves around the base 124 under the work applied by the blade 117/130. The central bulb 149 may take any suitable shape such as frustoconical as shown, or hemispherical.

To work the mixture, the lower surface 139 of the blade 130 comprises a pressing projection 128. The pressing projection 128 repeatedly depresses the ingredients during formation of the dough ball. For each movement or rotation of the blade 130 by the drive system, the pressing projection 128 depresses the dough ball. As the pressing projection 128 moves past the dough ball, the dough ball relaxes. Thus, the pressing projection 128 facilitates the repeated depression and relaxation of the dough ball in a manner similar to that performed by manual kneading.

For some mixtures, the pressing projection 128 would simply drive the mixture around the base of the cup without actually depressing and relaxing the mixture. To counter this phenomenon, the upper surface 145 of the base 124 comprises one or more protrusions 147 as shown in FIG. 5. There may be any number of projections 147.

The present projections 147 are equidistantly and radially disposed about the surface 145. The projections 147 are just large enough to provide resistance to oppose motion of the dough ball with the blade 117/130, but are not so large that they mix (or knead) the ingredients (or dough) or gather residue.

In use, the position sensing system ensures that opening 131 is disposed directly below the outlet of the dispenser. The dispenser is activated to dispense an ingredient. The blade is then driven further until the opening 131 is disposed directly below the outlet of a second dispenser that is then activated to dispense a second ingredient and so on for any other ingredients required in the mixture.

To ensure a consistent dough ball, consistent amounts of ingredients should be dispensed. One way of achieving this is to drive the dispensing mechanisms or open the dispensing mechanisms for a predetermined period of time so as to dispense a predetermined amount of each ingredient. However, as mentioned above, portions of ingredients being dispensed may not end up in the cup 116. Moreover, particularly for small flat edibles such as rotis, small variations in ingredient quantities can have a significant effect on the consistency of the cooked flat edible.

To avoid this, the drive system comprises a load detection system 108 (see FIG. 5—e.g. one or more load cells, such as a single, circular or annular load cell) for detecting a weight of ingredients dispensed into the cup. During dispensing, the drive system separates the blade 117/130 from the base 124 of the cup 116 by a sufficient distance such that the blade 117/130 does not influence the weight measurements taken by the load detection system 108. That distance may depend on the amounts and/or types of the ingredients being dispensed, or may be a predetermined distance for all flat edibles.

The weighing device or load detection system 108 is part of the mixing unit 112, or is in operational engagement with the mixing unit 112 (i.e. is positioned against or relative to the mixing unit 112 to enable the load cell to weigh the ingredients in the mixing unit) that comprises a container 116 into which the ingredients are dispensed.

The container 116 in each case is mounted on a base 124. Supporting the container 116 above the base 108, or otherwise positioned to experience the weight force of the container 116 is the weighing device 108. The weighing device comprises a load cell arrangement 120.

The mixing container 116 is disposed within, or forms part of, a housing. The base 124 may be held in fixed relation relative to the housing, may be integrally formed with the housing, or otherwise held in sufficiently fixed position to ensure accurate weight measurements can be taken by the load cell arrangement 120.

The container 116 is substantially cylindrical. The load cell arrangement 120 may comprise a plurality of load cells—e.g. a plurality of load cells disposed equidistantly around a circumference of the bottom/base of the container 116—but presently comprises a single load cell that, in some embodiments, is circular or annular. In embodiments where the load cells spaced are equidistantly relative to a circumference of the bottom 124 of the container 116, between the bottom 124 and base 118. In other embodiments, the load cell arrangement comprises a single load cell located centrally of the bottom 124, two or more load cells, or an annular load cell in which a centre of the annulus is centred on a centre of the bottom 124.

The load cell arrangement 120 measures the weight of ingredients dispensed into the container 116.

In addition, a dispenser may be deactivated shortly before the desired quantity of the corresponding ingredient has been weighed by the load detection system 108. This accounts for amounts of ingredients that have been dispensed but have not yet it the base of the cup 116. Alternatively, the dispensers may be operated at a first, fast rate to dispense a predetermined portion (i.e. a portion of the overall amount to be dispensed, such as 90%) very rapidly, and then be operated at a second, slower rate to more slowly dispense the remainder of the amount of the ingredient intended to be dispensed.

Once the desired quantities of ingredients have been dispensed, the drive system drives the blade 117/130 towards the ingredients. The drive system then drives the blade 117/130 to work (i.e. mix/knead) the ingredients to form the dough ball. During mixing, the drive system monitors development of the dough ball based on an amount of work applied to the mixture. That amount of work is determined based on a weight measurement detected by the load detection system. Therefore, while the mixture remains fairly liquid, little work will be done.

As more work is applied, the dough ball forms. During formation, gluten develops. Gluten development is a function of force/energy applied to dough ball, herein called “work”. The development of gluten makes the dough ball firmer. At the outset, the ingredients are spread across the base 124. The blade 117/130 therefor needs to be close to or on the base 124 to contact the ingredients to facilitate mixing. As the ingredients are mixed and gluten develops, the ingredients gather together. As a result, the height of the ingredients off the base 124 increases while the width across the base 124 decreases. To increase the distance between the blade 117/130 and base 124, the size of the mixing volume is increased by moving the cup 116 downwardly relative to the blade 117/130.

As mentioned above, the drive system may move either or both of the blade and cup to change the size of the mixing volume. In the embodiment shown, the drive system moves the cup to change a size of the mixing volume during development of the dough ball.

The drive system may change the size of the mixing volume based on a mixing time. The mixing time may be a fixed time or may depend on the type of flat edible being made, the quantities of ingredients or the types of ingredients.

The drive system may also change the size of the mixing volume depending on the degree of dough ball development. Therefore, if a particular mixture takes a bit longer or shorter to come together and for gluten to develop, which may be affected by ambient conditions or the temperature of ingredients when dispensed, the drive system will only move the cup 116 once the required amount of work has been performed on the mixture.

The drive system may also move the base 124 back and forth away from and towards the blade 117/130 at different times in the mixing cycle. Thus, the distance between the base 124 and blade 117/130 may follow a predetermined profile, that may involve only moving the base 124 away from the blade 117/130 or may include some back and forth motion.

Moving the base 124 away from the blade 117/130 also assists with separation of the dough ball, once formed, from the lower surface 139 of the blade 130. By the time the dough ball is formed, it is partly rounded and therefor partially separated from the blade.

In addition, since the drive system tips or tilts the cup 116 two dispense the dough ball—e.g. into a transfer mechanism—part of the separation of the cup 116 from the blade 117/130 will already have taken place by the cup 116 moving downwardly relative to the blade during mixing.

With reference to FIG. 6, the apparatus 100 comprises various system components that interact to control the apparatus 100 and enable user inputs or other external inputs to be used. FIG. 6 is a block diagram showing an exemplary computer device 600, e.g. a mobile computer device, for use in a mixing system for making dough balls or apparatus for making flat edibles. The computer device 600 may be any desired device though, in general, will form part of the apparatus for making flat edibles, or of the mixing system within that apparatus.

As shown, the computer device 600 includes the following components in electronic communication via a bus 606:
(a) a display 602;
(b) non-volatile (non-transitory) memory 604;
(c) random access memory (“RAM”) 608;
(d) N processing components 610;
(e) a transceiver component 612 that includes N transceivers; and
(f) user controls 614.

Although the components depicted in FIG. 6 represent physical components, FIG. 6 is not intended to be a hardware diagram. Thus, many of the components depicted in FIG. 6 may be realized by common constructs or distributed among additional physical components. Moreover, it is certainly contemplated that other existing and yet-to-be developed physical components and architectures may be utilized to implement the functional components described with reference to FIG. 6.

The display 602 generally operates to provide a presentation of content to a user, and may be realized by any of a variety of displays (e.g., CRT, LCD, HDMI, micro-projector and OLED displays). The display 602 may be a touchscreen for receiving inputs for controlling the cooking process or a number of flat edibles or mixtures to be produced.

In general, the non-volatile data storage 604 (also referred to as non-volatile memory) functions to store (e.g., persistently store) data and executable code. The executable code may comprise instructions for causing a mixing apparatus, or the N processing components, to perform the processes described herein.

In some embodiments for example, the non-volatile memory 604 includes bootloader code, modem software, operating system code, file system code, and code to facilitate the implementation components, well known to those of ordinary skill in the art, which are not depicted nor described for simplicity.

In many implementations, the non-volatile memory 604 is realized by flash memory (e.g., NAND or ONENAND memory), but it is certainly contemplated that other memory types may be utilized as well. Although it may be possible to execute the code from the non-volatile memory 604, the executable code in the non-volatile memory 604 is typically loaded into RAM 608 and executed by one or more of the N processing components 610.

The N processing components 610 (forming the control system) in connection with RAM 208 generally operate to execute the instructions stored in non-volatile memory 604. As one of ordinarily skill in the art will appreciate, the N processing components 610 may include a video processor, modem processor, DSP, graphics processing unit (GPU), and other processing components.

The transceiver component 612 includes N transceiver chains, which may be used for communicating with external devices via wireless networks. Each of the N transceiver chains may represent a transceiver associated with a particular communication scheme. For example, each transceiver may correspond to protocols that are specific to local area networks, cellular networks (e.g., a CDMA network, a GPRS network, a UMTS networks), and other types of communication networks. This can allow the apparatus 200 to update based on new cooking profiles acquired from a remote server, different ingredient profiles and other considerations.

Reference 616 represents inputs obtained from the apparatus or mixing unit itself, such as sensor inputs for determining load on the base 124 of the cup 116, the weight measurements taken by the load detection system 108 used to measure ingredients and/or the amount of work applied to a mixture/dough ball, temperatures of heating platens and others, that can be fed to the N processing components 610 to ensure accurate control of the mixing and/or cooking processes, or updating of ingredient amounts (stored in non-volatile memory 604) for future cooking cycles.

It should be recognized that FIG. 6 is merely exemplary and in one or more exemplary embodiments, the functions described herein may be implemented in hardware, software, firmware, or any combination thereof. If implemented in software, the functions may be stored on or transmitted over as one or more instructions or code encoded on a non-transitory computer-readable medium 604. Non-transitory computer-readable medium 604 includes both computer storage medium and communication medium including any medium that facilitates transfer of a computer program from one place to another. A storage medium may be any available medium that can be accessed by a computer.

Throughout this specification, unless the context requires otherwise, the word “comprise”, and variations such as “comprises” and “comprising”, will be understood to imply the inclusion of a stated integer or step or group of integers or steps but not the exclusion of any other integer or step or group of integers or steps.

The reference to any prior art in this specification is not, and should not be taken as, an acknowledgment or any form of suggestion that the prior art forms part of the common general knowledge.

1. A mixing system for making a dough ball, comprising:
a cup for receiving a plurality of ingredients to be mixed, the cup comprising a base and side wall;
a blade for mixing the ingredients in the cup to develop the dough ball, the blade and cup together defining a mixing volume; and
a drive system for moving at least one of the blade and the cup to change a size of the mixing volume.

2. The mixing system of claim 1, wherein the drive system moves at least one of the blade and the cup to change a size of the mixing volume during development of the dough ball.

3. The mixing system of claim 2, wherein the drive system changes the size of the mixing volume depending on at least one of mixing time and a degree of dough ball development. starting spacing depends on types of ingredients and their volumes.

4. The mixing system of claim 1, wherein the drive system comprises a first drive for driving the blade to mix the ingredients, and a second drive for moving the cup towards and away from the blade to change the size of the mixing volume.

5. The mixing system of claim 4, wherein the second drive is configured to tilt the cup to dispense the dough ball.

6. The mixing system of claim 1, wherein the blade is connected to the drive system by a magnetic mount.

7. The mixing system of claim 1, wherein the blade comprises a pressing projection on a lower surface for repeatedly depressing the ingredients with movement of the blade by the drive system, during formation of the dough ball.

8. The mixing system of claim 1, wherein the blade comprises a central bulb.

9. The mixing system of claim 1, wherein the base comprises an upper surface with one or more protrusions.

10. The mixing system of claim 1, wherein the drive system comprises a load detection system for detecting a weight of ingredients dispensed into the cup.

11. The mixing system of claim 10, wherein the drive system separates the blade from the base during dispensing of ingredients into the cup.

12. The mixing system of claim 1, wherein the drive system monitors development of the dough ball based on an amount of work applied to the ingredients.

13. The mixing system of claim 12, wherein the drive system comprises a load detection system for detecting a weight of ingredients dispensed into the cup and the drive system determines the amount of work based on a weight measurement detected by the load detection system.

14. An apparatus for making flat edibles, comprising:
a mixing system according to claim 1; and
a cooking assembly for cooking the dough ball, wherein the drive system causes the dough ball, after formation of the dough ball, to be deposited in or on the cooking assembly.

15. A method for forming a dough ball comprising:
spacing a blade from a base of a mixing cup to define a mixing volume;
dispensing a plurality of ingredients into the mixing volume;
moving the blade towards the ingredients; and
driving the blade using a drive system to mix the ingredients in the cup to develop the dough ball.

16. The method of claim 15, wherein driving the blade using a drive system to mix the ingredients in the cup to develop the dough ball comprises changing a size of the mixing volume during mixing of the ingredients.
